(19) United States
(12) Patent Application Publication
(10) Pub. No.: US 2026/0292643 A1
(43) Pub. Date: Sep. 24, 2026

(54) METHOD TO RECEIVE UNAVAILABILITY PERIOD IN CONNECTED MODE

(71) Applicant: MediaTek Singapore Pte. Ltd., Singapore (SG)

(72) Inventors: Marko NIEMI, Oulu (FI); Puneet ., Bengaluru (IN)

(73) Assignee: MediaTek Singapore Pte. Ltd., Singapore (SG)

(21) Appl. No.: 19/474,016

(22) PCT Filed: Sep. 13, 2024
(86) PCT No.: PCT/CN2024/118767

§ 371 Date: Oct. 9, 2025

(30) Foreign Application Priority Data
Sep. 13, 2023 (IN) 202321061530
Sep. 13, 2023 (IN) 202321061597
Feb. 26, 2024 (IN) 202421013797

(51) Int. Cl. H04W 36/32; H04L 5/00; H04W 36/00; H04W 60/04; H04W 60/06; H04W 76/30

(52) U.S. Cl. CPC H04W 36/32; H04L 5/0053; H04W 36/0022; H04W 60/04; H04W 60/06; H04W 76/30

(57) ABSTRACT

In an aspect of the disclosure, a method, a computer-readable medium, and an apparatus are provided. The method may be performed by a management entity of a network. In certain configurations, the network allows a UE to enter a connected mode. When the UE is already in the connected mode, the network determines an unavailability period for the UE, and transmits, to the UE, a downlink message with the information of the unavailability period. The network determines the UE to be unreachable during the unavailability period.

### CROSS-REFERENCE TO RELATED APPLICATION(S)

This application claims the benefits of Indian Provisional Application Serial No. 202321061530, entitled “Method to receive unavailability period in connected mode in EPS,” and Indian Provisional Application Serial No. 202321061597, entitled “Method to receive unavailability period in connected mode in 5G and future,” both filed on Sep. 13, 2023. This application claims the benefits of Indian Provisional Application Serial No. 202421013797, entitled “Method to receive unavailability period in connected mode in EPS,” filed on Feb. 26, 2024. The disclosure of each of the above-identified applications is expressly incorporated by reference herein in their entirety.

### BACKGROUND

### Field

The present disclosure relates generally to communication systems, and more particularly, to techniques of methods to receive unavailability period in connected mode.

### Background

The statements in this section merely provide background information related to the present disclosure and may not constitute prior art.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IOT)), and other requirements. Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The method may be performed by a management entity of a network. In certain configurations, the network allows a UE to enter a connected mode. When the UE is already in the connected mode, the network determines an unavailability period for the UE, and transmits, to the UE, a downlink message with the information of the unavailability period. The network determines the UE to be unreachable during the unavailability period.

In another aspect of the disclosure, a method, a computer-readable medium, and an apparatus are provided. The method may be performed by a UE. In certain configurations, the UE connects to a network and enters a connected mode. When the UE is in the connected mode, the UE receives, from the network, a downlink message with information of an unavailability period. In response to receiving the downlink message with the information of the unavailability period, the UE activates the unavailability period.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 is a diagram illustrating a base station in communication with a UE in an access network.

FIG. 3 illustrates an example logical architecture of a distributed access network.

FIG. 4 illustrates an example physical architecture of a distributed access network.

FIG. 5 is a diagram showing an example of a DL-centric slot.

FIG. 6 is a diagram showing an example of an UL-centric slot.

FIG. 7 is a diagram illustrating an example procedure between a UE and a network.

FIG. 8 is a diagram illustrating an example procedure for a UE to receive unavailability period initiated by a network.

FIG. 9 is a diagram illustrating an example procedure for a UE to receive unavailability period initiated by a network.

FIG. 10 is a flow chart of a method (process) for wireless communication of a management entity of a network.

FIG. 11 is a flow chart of a method (process) for wireless communication of a UE.

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunications systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

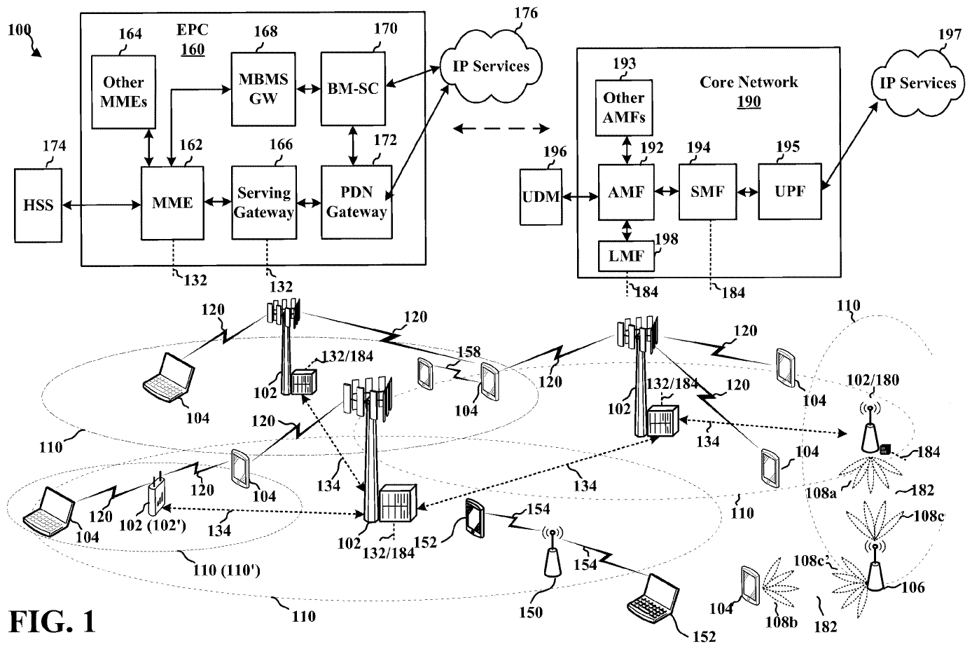

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., SI interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to 7 MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band (e.g., 3 GHz-300 GHz) has extremely high path loss and a short range. The mmW base station 180 may utilize beamforming 182 with the UE 104 to compensate for the extremely high path loss and short range.

The base station 180 may transmit a beamformed signal to the UE 104 in one or more transmit directions 108a. The UE 104 may receive the beamformed signal from the base station 180 in one or more receive directions 108b. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a location management function (LMF) 198, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the SMF 194 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the present disclosure may reference 5G New Radio (NR), the present disclosure may be applicable to other similar areas, such as LTE, Evolved Packet System (EPS), LTE-Advanced (LTE-A), Code Division Multiple Access (CDMA), Global System for Mobile communications (GSM), or other wireless/radio access technologies.

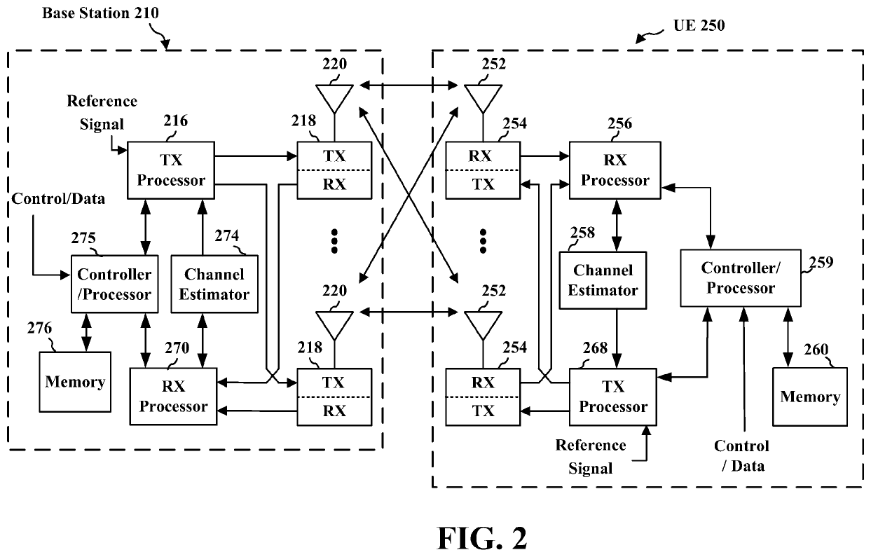

FIG. 2 is a block diagram of a base station 210 in communication with a UE 250 in an access network. In the DL, IP packets from the EPC 160 may be provided to a controller/processor 275. The controller/processor 275 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 275 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 216 and the receive (RX) processor 270 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 216 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 274 may be used to determine the coding and modulation scheme, as well as for spatial processing. The channel estimate may be derived from a reference signal and/or channel condition feedback transmitted by the UE 250. Each spatial stream may then be provided to a different antenna 220 via a separate transmitter 218TX. Each transmitter 218TX may modulate an RF carrier with a respective spatial stream for transmission.

At the UE 250, each receiver 254RX receives a signal through its respective antenna 252. Each receiver 254RX recovers information modulated onto an RF carrier and provides the information to the receive (RX) processor 256. The TX processor 268 and the RX processor 256 implement layer 1 functionality associated with various signal processing functions. The RX processor 256 may perform spatial processing on the information to recover any spatial streams destined for the UE 250. If multiple spatial streams are destined for the UE 250, they may be combined by the RX processor 256 into a single OFDM symbol stream. The RX processor 256 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 210. These soft decisions may be based on channel estimates computed by the channel estimator 258. The soft decisions are then decoded and deinterleaved to recover the data and control signals that were originally transmitted by the base station 210 on the physical channel. The data and control signals are then provided to the controller/processor 259, which implements layer 3 and layer 2 functionality.

The controller/processor 259 can be associated with a memory 260 that stores program codes and data. The memory 260 may be referred to as a computer-readable medium. In the UL, the controller/processor 259 provides demultiplexing between transport and logical channels, packet reassembly, deciphering, header decompression, and control signal processing to recover IP packets from the EPC 160. The controller/processor 259 is also responsible for error detection using an ACK and/or NACK protocol to support HARQ operations.

Similar to the functionality described in connection with the DL transmission by the base station 210, the controller/processor 259 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 258 from a reference signal or feedback transmitted by the base station 210 may be used by the TX processor 268 to select the appropriate coding and modulation schemes, and to facilitate spatial processing. The spatial streams generated by the TX processor 268 may be provided to different antenna 252 via separate transmitters 254TX. Each transmitter 254TX may modulate an RF carrier with a respective spatial stream for transmission. The UL transmission is processed at the base station 210 in a manner similar to that described in connection with the receiver function at the UE 250. Each receiver 218RX receives a signal through its respective antenna 220. Each receiver 218RX recovers information modulated onto an RF carrier and provides the information to a RX processor 270.

The controller/processor 275 can be associated with a memory 276 that stores program codes and data. The memory 276 may be referred to as a computer-readable medium. In the UL, the controller/processor 275 provides demultiplexing between transport and logical channels, packet reassembly, deciphering, header decompression, control signal processing to recover IP packets from the UE 250. IP packets from the controller/processor 275 may be provided to the EPC 160. The controller/processor 275 is also responsible for error detection using an ACK and/or NACK protocol to support HARQ operations.

New radio (NR) may refer to radios configured to operate according to a new air interface (e.g., other than Orthogonal Frequency Divisional Multiple Access (OFDMA)-based air interfaces) or fixed transport layer (e.g., other than Internet Protocol (IP)). NR may utilize OFDM with a cyclic prefix (CP) on the uplink and downlink and may include support for half-duplex operation using time division duplexing (TDD). NR may include Enhanced Mobile Broadband (eMBB) service targeting wide bandwidth (e.g. 80 MHz beyond), millimeter wave (mmW) targeting high carrier frequency (e.g. 60 GHz), massive MTC (mMTC) targeting non-backward compatible MTC techniques, and/or mission critical targeting ultra-reliable low latency communications (URLLC) service.

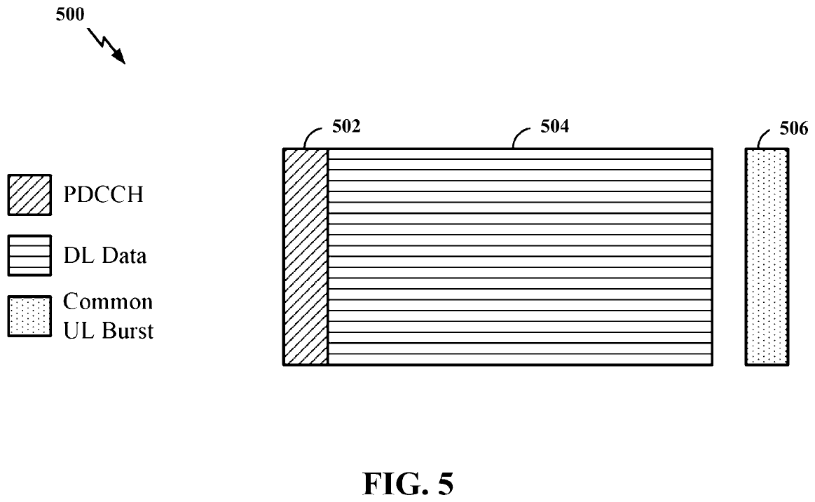

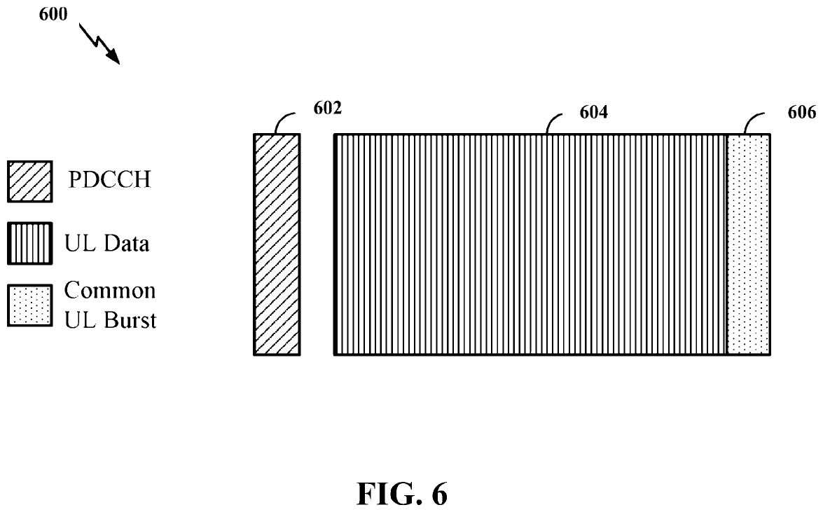

A single component carrier bandwidth of 100 MHz may be supported. In one example, NR resource blocks (RBs) may span 12 sub-carriers with a sub-carrier bandwidth of 60 kHz over a 0.25 ms duration or a bandwidth of 30 kHz over a 0.5 ms duration (similarly, 50 MHz BW for 15 kHz SCS over a 1 ms duration). Each radio frame may consist of 10 subframes (10, 20, 40 or 80 NR slots) with a length of 10 ms. Each slot may indicate a link direction (i.e., DL or UL) for data transmission and the link direction for each slot may be dynamically switched. Each slot may include DL/UL data as well as DL/UL control data. UL and DL slots for NR may be as described in more detail below with respect to FIGS. 5 and 6.

The NR RAN may include a central unit (CU) and distributed units (DUs). A NR BS (e.g., gNB, 5G Node B, Node B, transmission reception point (TRP), access point (AP)) may correspond to one or multiple BSs. NR cells can be configured as access cells (ACells) or data only cells (DCells). For example, the RAN (e.g., a central unit or distributed unit) can configure the cells. DCells may be cells used for carrier aggregation or dual connectivity and may not be used for initial access, cell selection/reselection, or handover. In some cases DCells may not transmit synchronization signals (SS) in some cases DCells may transmit SS. NR BSs may transmit downlink signals to UEs indicating the cell type. Based on the cell type indication, the UE may communicate with the NR BS. For example, the UE may determine NR BSs to consider for cell selection, access, handover, and/or measurement based on the indicated cell type.

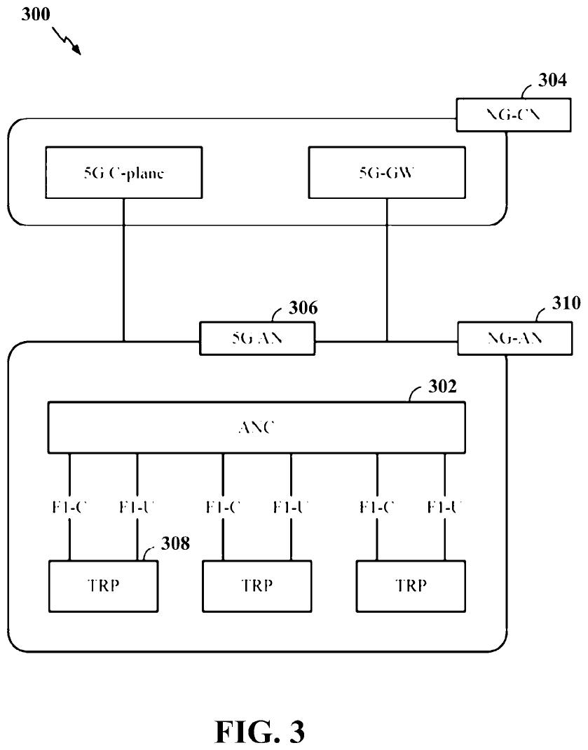

FIG. 3 illustrates an example logical architecture of a distributed RAN 300, according to aspects of the present disclosure. A 5G access node 306 may include an access node controller (ANC) 302. The ANC may be a central unit (CU) of the distributed RAN. The backhaul interface to the next generation core network (NG-CN) 304 may terminate at the ANC. The backhaul interface to neighboring next generation access nodes (NG-ANs) 310 may terminate at the ANC. The ANC may include one or more TRPs 308 (which may also be referred to as BSs, NR BSs, Node Bs, 5G NBs, APs, or some other term). As described above, a TRP may be used interchangeably with “cell.”

The TRPs 308 may be a distributed unit (DU). The TRPs may be connected to one ANC (ANC 302) or more than one ANC (not illustrated). For example, for RAN sharing, radio as a service (RaaS), and service specific ANC deployments, the TRP may be connected to more than one ANC. A TRP may include one or more antenna ports. The TRPs may be configured to individually (e.g., dynamic selection) or jointly (e.g., joint transmission) serve traffic to a UE.

The local architecture of the distributed RAN 300 may be used to illustrate fronthaul definition. The architecture may be defined that support fronthauling solutions across different deployment types. For example, the architecture may be based on transmit network capabilities (e.g., bandwidth, latency, and/or jitter). The architecture may share features and/or components with LTE. According to aspects, the next generation AN (NG-AN) 310 may support dual connectivity with NR. The NG-AN may share a common fronthaul for LTE and NR.

The architecture may enable cooperation between and among TRPs 308. For example, cooperation may be preset within a TRP and/or across TRPs via the ANC 302. According to aspects,

According to aspects, a dynamic configuration of split logical functions may be present within the architecture of the distributed RAN 300. The PDCP, RLC, MAC protocol may be adaptably placed at the ANC or TRP.

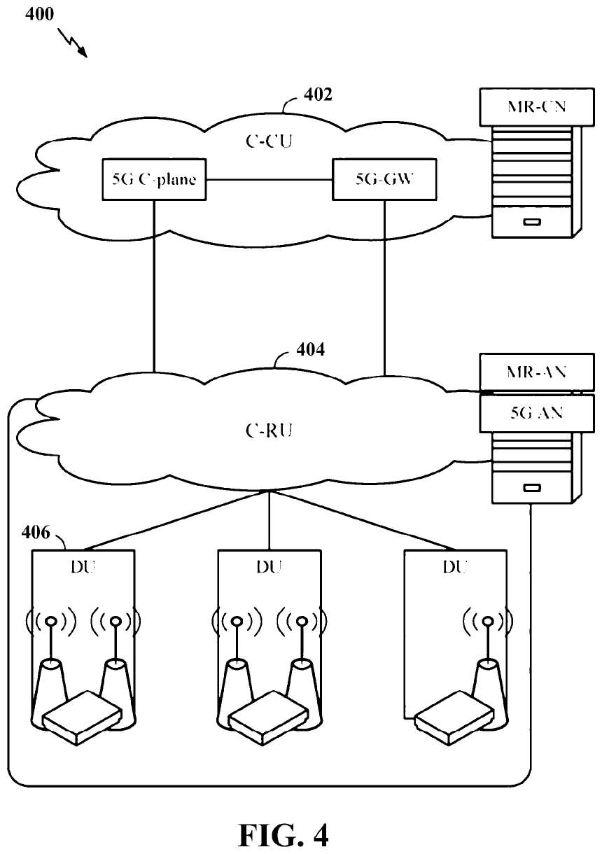

FIG. 4 illustrates an example physical architecture of a distributed RAN 400, according to aspects of the present disclosure. A centralized core network unit (C-CU) 402 may host core network functions. The C-CU may be centrally deployed. C-CU functionality may be offloaded (e.g., to advanced wireless services (AWS)), in an effort to handle peak capacity. A centralized RAN unit (C-RU) 404 may host one or more ANC functions. Optionally, the C-RU may host core network functions locally. The C-RU may have distributed deployment. The C-RU may be closer to the network edge. A distributed unit (DU) 406 may host one or more TRPs. The DU may be located at edges of the network with radio frequency (RF) functionality.

FIG. 5 is a diagram 500 showing an example of a DL-centric slot. The DL-centric slot may include a control portion 502. The control portion 502 may exist in the initial or beginning portion of the DL-centric slot. The control portion 502 may include various scheduling information and/or control information corresponding to various portions of the DL-centric slot. In some configurations, the control portion 502 may be a physical DL control channel (PDCCH), as indicated in FIG. 5. The DL-centric slot may also include a DL data portion 504. The DL data portion 504 may sometimes be referred to as the payload of the DL-centric slot. The DL data portion 504 may include the communication resources utilized to communicate DL data from the scheduling entity (e.g., UE or BS) to the subordinate entity (e.g., UE). In some configurations, the DL data portion 504 may be a physical DL shared channel (PDSCH).

The DL-centric slot may also include a common UL portion 506. The common UL portion 506 may sometimes be referred to as an UL burst, a common UL burst, and/or various other suitable terms. The common UL portion 506 may include feedback information corresponding to various other portions of the DL-centric slot. For example, the common UL portion 506 may include feedback information corresponding to the control portion 502. Non-limiting examples of feedback information may include an ACK signal, a NACK signal, a HARQ indicator, and/or various other suitable types of information. The common UL portion 506 may include additional or alternative information, such as information pertaining to random access channel (RACH) procedures, scheduling requests (SRs), and various other suitable types of information.

As illustrated in FIG. 5, the end of the DL data portion 504 may be separated in time from the beginning of the common UL portion 506. This time separation may sometimes be referred to as a gap, a guard period, a guard interval, and/or various other suitable terms. This separation provides time for the switch-over from DL communication (e.g., reception operation by the subordinate entity (e.g., UE)) to UL communication (e.g., transmission by the subordinate entity (e.g., UE)). One of ordinary skill in the art will understand that the foregoing is merely one example of a DL-centric slot and alternative structures having similar features may exist without necessarily deviating from the aspects described herein.

FIG. 6 is a diagram 600 showing an example of an UL-centric slot. The UL-centric slot may include a control portion 602. The control portion 602 may exist in the initial or beginning portion of the UL-centric slot. The control portion 602 in FIG. 6 may be similar to the control portion 502 described above with reference to FIG. 5. The UL-centric slot may also include an UL data portion 604. The UL data portion 604 may sometimes be referred to as the pay load of the UL-centric slot. The UL portion may refer to the communication resources utilized to communicate UL data from the subordinate entity (e.g., UE) to the scheduling entity (e.g., UE or BS). In some configurations, the control portion 602 may be a physical DL control channel (PDCCH).

As illustrated in FIG. 6, the end of the control portion 602 may be separated in time from the beginning of the UL data portion 604. This time separation may sometimes be referred to as a gap, guard period, guard interval, and/or various other suitable terms. This separation provides time for the switch-over from DL communication (e.g., reception operation by the scheduling entity) to UL communication (e.g., transmission by the scheduling entity). The UL-centric slot may also include a common UL portion 606. The common UL portion 606 in FIG. 6 may be similar to the common UL portion 506 described above with reference to FIG. 5. The common UL portion 606 may additionally or alternatively include information pertaining to channel quality indicator (CQI), sounding reference signals (SRSs), and various other suitable types of information. One of ordinary skill in the art will understand that the foregoing is merely one example of an UL-centric slot and alternative structures having similar features may exist without necessarily deviating from the aspects described herein.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

In certain configurations, when the UE and the network (e.g., an AMF or a MME) both support unavailability period, and an event is triggered in the UE making the UE unavailable for a certain period of time, the UE may initiate a procedure to activate the unavailability period and store its 5GMM and 5GSM context in a USIM or a non-volatile memory to be able to reuse it after the unavailability period. Specifically, to activate the unavailability period, the UE (as the initiating entity) provides an unavailability period duration to the network in a corresponding registration, attach or tracking area updating (TAU) procedure or a corresponding de-registration or detach procedure (e.g., see 3GPP Technical Specification 23.501 and 23.502). The support for the unavailability period is negotiated in the registration/attach/TAU procedure. If the UE provided an unavailability period duration in the last registration/attach/TAU procedure or the de-registration/detach procedure, the network (e.g., AMF or MME) considers the UE unreachable until the UE re-register or re-attach for a normal service without providing an unavailability period duration. During the registration procedure, the network may determine the value of the periodic registration update timer (i.e., the timer T3512) provided to the UE based on the unavailability period duration. The network releases the N1 signaling connection after the completion of the registration/attach/TAU procedure in which the UE provided an unavailability period duration.

In the procedure as described, the UE serves as the initiating entity to activate the unavailability period. However, there is no existing method defined for the network to serve as the initiating entity to activate the unavailability period when the UE is already in the connected mode. Therefore, there is a need for a method allowing the network to notify the UE to activate the unavailability period (e.g., by notifying, to the UE, the unavailability duration IE, if available; or a start of unavailability period, if available; or both; or the coverage notification indication IE.

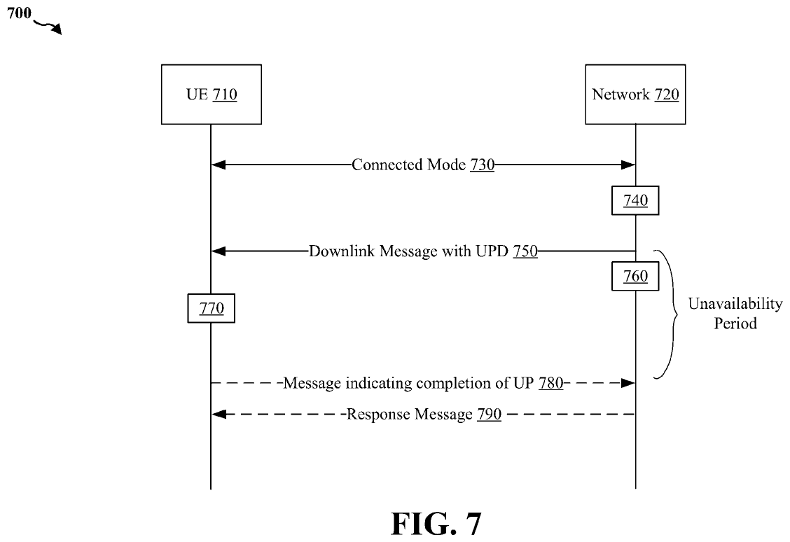

FIG. 7 is a diagram illustrating an example procedure between a UE and a network. Specifically, in the procedure 700, the UE 710 and the network 720 (e.g., an AMF or a MME) both support the unavailability period feature. As shown in FIG. 7, when the UE 710 is in a coverage (e.g., within the 5G NR satellite access, or within the EPS) of the network 720 with a corresponding mobility management (MM) protocol such as 5GMM or EPS Mobility Management (EMM) in EPS, at operation 730, the UE 710 is in a connected mode (e.g., the 5GMM-CONNECTED mode when being connected to 5GC or the EMM-CONNECTED mode when being connected to EPC) with the network 720. Specifically, the UE 710 may firstly become registered or attached to the network 720, and then the UE 710 may enter the connected mode (e.g., transit from an idle mode to the connected mode).

At operation 740, when the UE 710 is already in the connected mode, an event may occur to trigger the network 720 to determine an unavailability period for the UE 710, such that the UE 710 may be deemed unavailable for a period of time. Specifically, the event triggering the network 720 to determine the unavailability period for the UE 710 may include: (1) satellite coverage availability information which may result in a UE out-of-coverage period, or UE-specific events, e.g., the UE 710 performing a software update, and (2) a loss of network coverage (e.g., NR satellite access discontinuous coverage) that results in an upcoming loss of coverage or unavailability period.

Upon being triggered by the event, the network 720 initiates a procedure to transmit a downlink message 750, which includes information of the unavailability period, to the UE 710. In certain configurations, the downlink message 750 may be a configuration update command message or a deregistration request message in 5G, a downlink NAS transport message or a downlink generic NAS transport message. In certain configurations, the information of the unavailability period in the request message 750 may be an unavailability period duration (UPD) (if known), a time stamp and/or a timer value of a start of the unavailability period (if known), or an indication value of a start of the coverage notification (indicating the upcoming loss of coverage or unavailability period) of the network 720. In one embodiment, the downlink message 750 may also include other information related to the unavailability period, such as the indication and type of unavailability.

At the UE 710, upon receiving the downlink message 750 from the network 720, optionally the UE 710 may transmit a corresponding acknowledgement message back to the network 720 to confirm receipt of the downlink message 750. In certain configurations, the acknowledgement message may be a configuration update complete message (in response to the downlink message being the configuration update command message) or a deregistration complete message (in response to the downlink message being the deregistration request message). At operation 760, after transmitting the downlink message 750 (and optionally upon receiving the acknowledgement message), the network 720 may consider the UE 710 is unreachable. In this case, the UE 710 is determined by the network 720 to be unreachable during the unavailability period.

On the other hand, the UE 710 may also process the downlink message 750 to retrieve the information of the unavailability period therein, such that the UE 710 understands the initiation of the procedure by the network 720. At operation 770, the UE 710 may also activate the unavailability period, and perform one or more corresponding actions. In certain configurations, examples of the corresponding actions include: storing the information of the unavailability period (e.g., UDP, the start of the unavailability period, etc.); when corresponding earlier stored information of unavailability period (e.g., an earlier UDP, etc.) exists, deleting the corresponding earlier stored information of unavailability period; informing the information of the unavailability period to upper layers; starting an unavailability period timer according to the information of the unavailability period; and/or entering a no-cell-available state during the unavailability period. In certain configurations, the UE may also store its corresponding 5GMM and 5GSM context in a USIM or a non-volatile memory, and how the UE store its corresponding context as well as the information of the unavailability period is UE-implementation specific.

In certain configurations, since the network 720 considers the UE 710 to be unreachable during the unavailability period, the network 720 may determine that the UE 710 requires a further procedure when the unavailability period ends. In other words, the network 720 may determine the UE 710 to be unreachable (i.e., in the unavailability period) until the UE 710 performs the further procedure. For example, optionally, the UE 710 may transmit a message 780 indicating the completion of the unavailability period to the network 720. In certain configurations, the UE 710 may transmit a registration request message as the message 780 to the network 720 to re-register to the network 720 for normal services. In this case, the registration request message 780 is without an unavailability period duration, thus indicating that the UE 710 does not intend to initiate another unavailability period. At the network 720, upon receiving the message 780 without the unavailability period duration, the network 720 determines that the unavailability period for the UE 710 has ended, and that the UE 710 is now reachable again. In response to the message 780, the network 720 then transmits a response message 790 back to the UE 710 to confirm receipt of the message 780.

In the procedure 700, the network 720 considers the UE 710 to be unreachable after transmitting the downlink message 750. Specifically, the network 720 may consider the UE 710 to be unreachable during the unavailability period immediately after the downlink message 750 with the information of the unavailability period is transmitted to the UE 710, as it is possible that the UE 710 becomes unreachable immediately and may not transmit the acknowledgement message back to the network 720 (e.g., the acknowledgement message may be lost due to loss of network coverage or the UE 710 is configured to respond the downlink message, etc.).

In certain configurations, the network 720 may consider the UE 710 to be unreachable after receiving the acknowledgement message from the UE 710.

In certain configurations, after transmitting the downlink message 750 with the information of the unavailability period, the network 720 may further release the NAS signaling connection for the UE 710. In this case, the network 720 may consider the UE 710 is unreachable after releasing the NAS signaling connection.

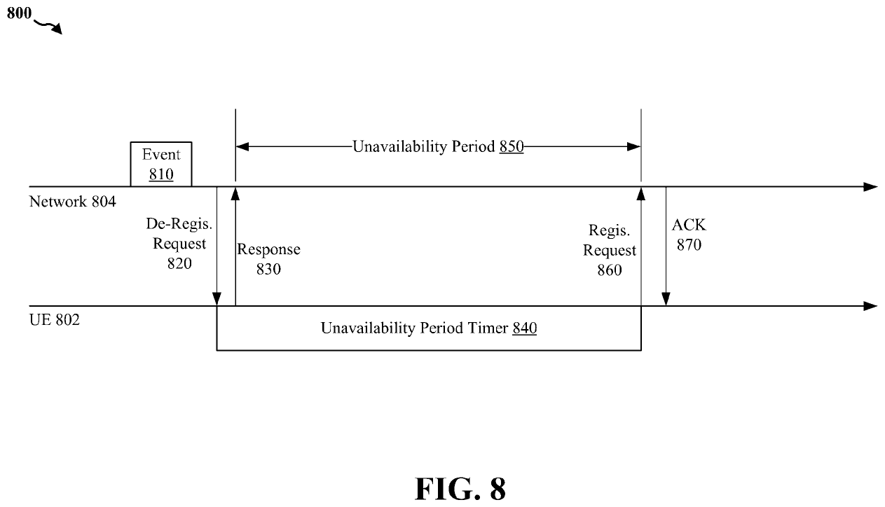

FIG. 8 is a diagram illustrating an example procedure for a UE to receive unavailability period initiated by a network. In the procedure 800, the UE 802 (e.g., UE 710) is in a connected mode with the network 804 (e.g., network 720). As shown in FIG. 8, at operation 810, an event triggers the network 804 to determine an unavailability period. The network 804 transmits a de-registration request message 820 as the downlink message with the information of the unavailability period to the UE 802. At the UE 802, upon receiving the de-registration request message 820, the UE 802 may transmit a response 830 to the de-registration request message 820 back to the network 804, and starts an unavailability period timer 840. At the network 804, upon receiving the response 830, the network 804 considers the UE 802 is unreachable for the unavailability period 850. It should be noted that, since the UE 802 is de-registered, an additional re-registration procedure is required for the UE 802. Thus, there is no need for the network 804 to start a corresponding unavailability period timer in the unavailability period 850, and the network 804 considers the UE 802 to be unreachable until the network 804 receives another registration request message.

At the UE 802, when the unavailability period timer 840 expires, the UE 802 transmits a registration request message 860 to the network 804, and the registration request message 860 is without another unavailability period duration. Upon receiving the registration request message 860, the network 804 determines that the unavailability period 850 ends, and transmits a corresponding registration acknowledgement message 870 to the UE 802.

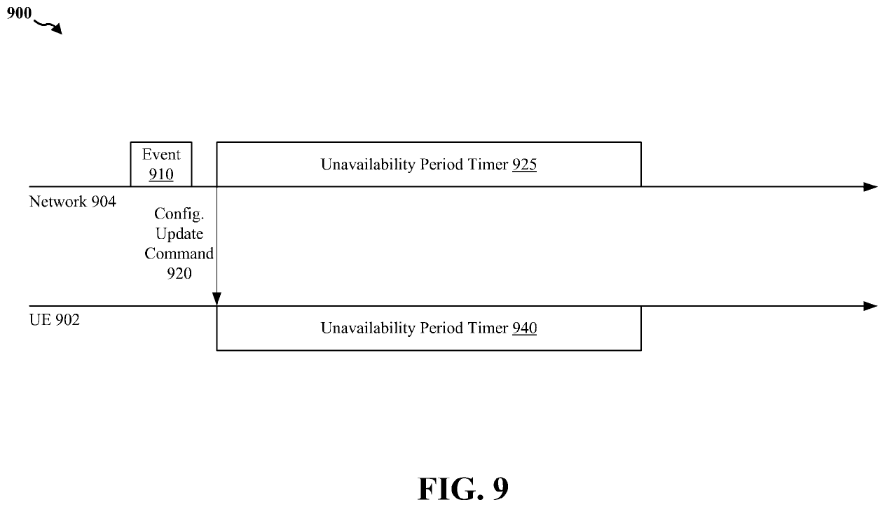

FIG. 9 is a diagram illustrating an example procedure for a UE to receive unavailability period initiated by a network. In the procedure 900, the UE 902 (e.g., UE 710) is in a connected mode with the network 904 (e.g., network 720). As shown in FIG. 9, at operation 910, an event triggers the network 804 to determine an unavailability period. The network 904 transmits a configuration update command message 920 as the downlink message with the information of the unavailability period to the UE 902, and immediately starts an unavailability period timer 925 for the UE 902. At the UE 902, upon receiving the configuration update command message 920, the UE 802 may transmit a corresponding acknowledgement (ACK) message back to the network 904, and starts an unavailability period timer 940. Since the network 904 has already started the unavailability period timer 925, the acknowledgement message does not affect the start of the unavailability period at the network 904. In other words, the network 904 may determine that the UE 902 is unreachable regardless of whether the acknowledgement message is successfully received from the UE 902 or not. Further, the network 904 does not require the UE 902 to perform a correspond procedure (e.g., a re-registration procedure) at the end of the unavailability period, as the unavailability period for the UE 902 ends when the unavailability period timers 925 and 940 expire.

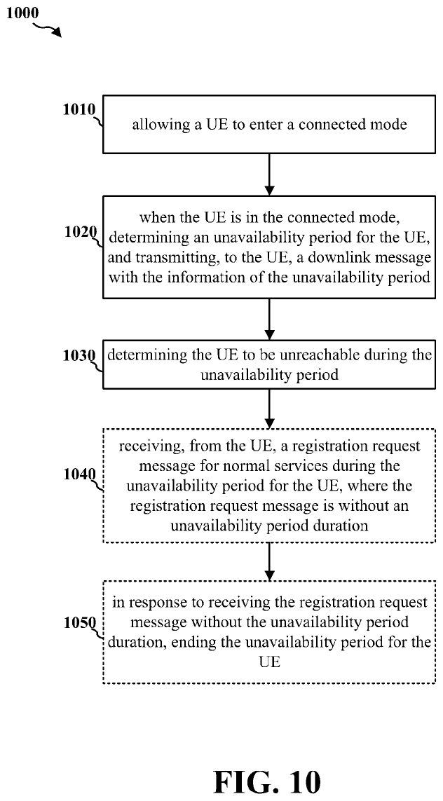

FIG. 10 is a flow chart of a method (process) for wireless communication of a management entity of a network. The method may be performed by a management entity (e.g., AMF or MME) of a network (e.g., network 720, 804 or 904), which may be a 5GC or an EPC. At procedure 1010, the network allows a UE to enter a connected mode. At procedure 1020, when the UE is already in the connected mode, the network determines an unavailability period for the UE, and transmits, to the UE, a downlink message with the information of the unavailability period. At procedure 1030, the network determines the UE to be unreachable during the unavailability period. Optionally, at procedure 1040, the network receives, from the UE, a registration request message for normal services during the unavailability period for the UE, and the registration request message is without an unavailability period duration. At procedure 1050, in response to receiving the registration request message without the unavailability period duration, the network ends the unavailability period for the UE.

In certain configurations, the unavailability period for the UE is activated after the downlink message with the information of the unavailability period is transmitted to the UE.

In certain configurations, the network further receives, from the UE, an acknowledgement message, and the unavailability period for the UE is activated after receiving the acknowledgement message from the UE. In certain configurations, the acknowledgement message is a configuration update complete message or a deregistration complete message.

In certain configurations, after transmitting the downlink message with the information of the unavailability period, the network releases NAS signaling connection for the UE, and the unavailability period for the UE is activated after releasing the NAS signaling connection.

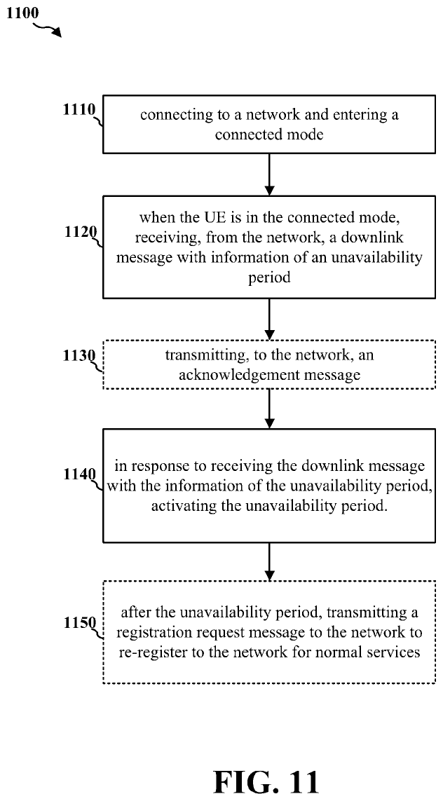

FIG. 11 is a flow chart of a method (process) for wireless communication of a UE. The method may be performed by a UE (e.g., UE 710, 802 or 902). At procedure 1110, the UE connects to a network and enters a connected mode. At procedure 1120, when the UE is in the connected mode, the UE receives, from the network, a downlink message with information of an unavailability period. Optionally, at procedure 1130, the UE transmits, to the network, an acknowledgement message. At procedure 1140, in response to receiving the downlink message with the information of the unavailability period, the UE activates the unavailability period. Optionally, at procedure 1150, after the unavailability period, the UE transmits a registration request message to the network to re-register to the network for normal services. The registration request message is without an unavailability period duration.

In certain configurations, the acknowledgement message is a configuration update complete message if the downlink message is a configuration update command message or a deregistration complete message if the downlink message is a deregistration request message.

In certain configurations, the information of the unavailability period includes at least one of: an UPD of the unavailability period, a time stamp or a timer value of a start of the unavailability period, and an indication value of a start of a coverage notification of the network.

In certain configurations, the UE is connected to the network with 5GMM or EMM.

In certain configurations, the downlink message is a 5GMM message if the UE is connected to the 5G network or an EMM message the UE is connected to an EPS network.

In certain configurations, the downlink message is a configuration update command message, a deregistration request message, a downlink NAS transport message, or a downlink generic NAS transport message.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication of a management entity of a network, comprising:
allowing a user equipment (UE) to enter a connected mode;
when the UE is in the connected mode, determining an unavailability period for the UE, and transmitting, to the UE, a downlink message with the information of the unavailability period; and
determining the UE to be unreachable during the unavailability period.

2. The method of claim 1, wherein the information of the unavailability period includes at least one of:
an unavailability period duration (UPD) of the unavailability period;
a time stamp or a timer value of a start of the unavailability period; and
an indication value of a start of a coverage notification of the network.

3. The method of claim 1, wherein the UE is connected to the network with fifth generation (5G) mobility management (MM) or EPS mobility management (EMM).

4. The method of claim 3, wherein the downlink message is a 5GMM message if the UE is connected to the 5G network or an EMM message the UE is connected to an EPS network.

5. The method of claim 4, wherein the downlink message is a configuration update command message, a deregistration request message, a downlink non-access stratum (NAS) transport message, or a downlink generic NAS transport message.

6. The method of claim 1, further comprising:
receiving, from the UE, a registration request message for normal services during the unavailability period for the UE, wherein the registration request message is without an unavailability period duration; and
in response to receiving the registration request message without the unavailability period duration, ending the unavailability period for the UE.

7. The method of claim 1, wherein the UE is determined to be unreachable during the unavailability period after the downlink message with the information of the unavailability period is transmitted to the UE.

8. The method of claim 1, further comprising:
receiving, from the UE, an acknowledgement message,
wherein the UE is determined to be unreachable during the unavailability period after receiving the acknowledgement message from the UE.

9. The method of claim 8, wherein the acknowledgement message is a configuration update complete message if the downlink message is a configuration update command message or a deregistration complete message if the downlink message is a deregistration request message.

10. The method of claim 1, further comprising:
after transmitting the downlink message with the information of the unavailability period, releasing non-access stratum (NAS) signaling connection for the UE,
wherein the UE is determined to be unreachable during the unavailability period after releasing the NAS signaling connection.

11. An apparatus for wireless communication, the apparatus being a management entity of a network, comprising:
a memory; and
at least one processor coupled to the memory, the processor being configured to:
allow a user equipment (UE) to enter a connected mode;
when the UE is in the connected mode, determine an unavailability period for the UE, and transmit, to the UE, a downlink message with the information of the unavailability period; and
activate the unavailability period for the UE, wherein the UE is determined to be unreachable in the unavailability period.

12. The apparatus of claim 11, wherein the information of the unavailability period includes at least one of:
an unavailability period duration (UPD) of the unavailability period;
a time stamp or a timer value of a start of the unavailability period; and
an indication value of a start of a coverage notification of the network.

13. The apparatus of claim 11, wherein the UE is connected to the network with fifth generation (5G) mobility management (MM) or EPS mobility management (EMM).

14. The apparatus of claim 11, wherein the downlink message is a configuration update command message, a deregistration request message, a downlink non-access stratum (NAS) transport message, or a downlink generic NAS transport message.

15. A method of wireless communication of a user equipment (UE), comprising:
connecting to a network and entering a connected mode;
when the UE is in the connected mode, receiving, from the network, a downlink message with information of an unavailability period; and
in response to receiving the downlink message with the information of the unavailability period, activating the unavailability period.

16. The method of claim 15, wherein the information of the unavailability period includes at least one of:
an unavailability period duration (UPD) of the unavailability period;
a time stamp or a timer value of a start of the unavailability period; and
an indication value of a start of a coverage notification of the network.

17. The method of claim 15, wherein the UE is connected to the network with fifth generation (5G) mobility management (MM) or EPS mobility management (EMM).

18. The method of claim 17, wherein the downlink message is a downlink 5GMM message if the UE is connected to the 5G network or a downlink EMM message the UE is connected to EPS network.

19. The method of claim 15, further comprising:
transmitting, to the network, an acknowledgement message,
wherein the acknowledgement message is a configuration update complete message if the downlink message is the configuration update command message or a deregistration complete message if the downlink message is the deregistration request message.

20. The method of claim 15, further comprising:
in response to receiving the downlink message with the information of the unavailability period, performing one or more actions including:
storing the information of the unavailability period;
when corresponding earlier stored information of unavailability period exists, deleting the corresponding earlier stored information of unavailability period;
informing the information of the unavailability period to upper layers;
starting an unavailability period timer according to the information of the unavailability period; and
entering a no-cell-available state during the unavailability period.
